(19) United States
(12) Patent Application Publication
(10) Pub. No.: US 2025/0338288 A1
(43) Pub. Date: Oct. 30, 2025

(54) METHODS FOR PDCCH MONITORING IN SUBBAND-FULLDUPLEX NETWORK

(71) Applicant: MediaTek Singapore Pte. Ltd., Singapore (SG)

(72) Inventors: Jozsef Gabor NEMETH, Cambridge (GB); Mohammed S Aleabe AL-IMARI, Cambridge (GB)

(21) Appl. No.: 18/875,315

(22) PCT Filed: Aug. 1, 2023
(86) PCT No.: PCT/CN2023/110527

§ 371 Date: Dec. 16, 2024

Related U.S. Application Data
(60) Provisional application No. 63/371,237, filed on Aug. 12, 2022.

(51) Int. Cl. H04W 72/232; H04L 5/00; H04W 72/0446

(52) U.S. Cl. CPC H04W 72/232; H04L 5/0053; H04W 72/0446

(57) ABSTRACT

Techniques pertaining to physical downlink control channel (PDCCH) monitoring in subband-fullduplex (SBFD) networks are described. A user equipment (UE) determines whether or not to disable physical downlink control channel (PDCCH) monitoring. Based on a result of the determining, the UE either: (i) disables the PDCCH monitoring responsive to a condition being met; or (ii) performs the PDCCH monitoring. In some cases, the condition includes there being a collision with an SBFD configuration of the UE by one or more symbols occupied by a control resource set (CORESET).

### CROSS REFERENCE TO RELATED PATENT APPLICATION(S)

The present disclosure is part of a non-provisional application claiming the priority benefit of U.S. Patent Application No. 63/371,237, filed 12 Aug. 2022, the content of which herein being incorporated by reference in its entirety.

### TECHNICAL FIELD

The present disclosure is generally related to mobile communications and, more particularly, to methods for physical downlink control channel (PDCCH) monitoring in subband-fullduplex (SBFD) networks.

### BACKGROUND

Unless otherwise indicated herein, approaches described in this section are not prior art to the claims listed below and are not admitted as prior art by inclusion in this section.

In wireless communications, such as mobile communications under the 3rd Generation Partnership Project (3GPP) specification(s) for 5th Generation (5G) New Radio (NR), in non-overlapping SBFD radio access network (RAN) deployments, a user equipment (UE) operates in half-duplex manner in either transmission or reception at a time, whereas a base station (e.g., gNB) can transmit and receive concurrently on non-overlapping subbands of a carrier. As an example, the gNB receives from UE #1 and UE #2 over an uplink (UL) subband while transmitting to UE #3 over downlink (DL) subband(s). The partition of a slot or symbols into DL and UL subbands may be referred to as an SBFD partition format. A periodic pattern of time-division duplex (TDD) and SBFD configurations per slots/symbols can be referred to as an SBFD layout configuration. Legacy UEs only support TDD configuration features, and their transmission and reception are governed solely by scheduling and applied TDD configurations. In contrast, for enhanced UEs, a possible work assumption is that the gNB shares the knowledge about SBFD layout.

Current 3GPP specifications provide flexible solutions for control resource set (CORESET) resource allocation and PDCCH monitoring, which may suit SBFD partitioned symbols as well as in other aspects. CORESET frequency-domain resource allocation (FDRA) is based on a bitmap of resource block (RB) groups consisting of six RBs each, thereby readily allowing for non-contiguous resource allocations. The grid starts from Common RB #0, and aggregations can spread over distant control-channel elements (CCEs). Up to three CORESETs can be configured and monitored per bandwidth part (BWP). This allows configuration of different CORESETs for SBFD and non-SBFD slots/symbols and using them with different search spaces. The time pattern of PDCCH monitoring is defined by search spaces, each of which defines a slot period and offset, a slot duration and a symbol bitmap. Up to ten search spaces can be configured per PDCCH-Config.

Using existing features, although PDCCH monitoring (including AL16) over non-contiguous set of DL RB groups in SBFD partitioned slots/symbols is feasible, the flexibility may be limited, however. Configuring PDCCH monitoring over different CORESETs for SBFD and DL-only slots/symbols will require configuring separate search spaces, possibly for each slot in the periodic SBFD partition pattern, each with the same slot periodicity but different slot offsets. This would quickly use up the maximum number of search spaces that can be configured. Thus, it is necessary to bring flexibility enhancements to search space configuration while allowing adaptation to SBFD partitioning (e.g., CORESETs or search spaces being linked to SBFD subbands). Therefore, there is a need for a solution of PDCCH monitoring in SBFD networks.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving PDCCH monitoring in SBFD networks. It is believed that implementations of various proposed schemes in accordance with the present disclosure may address or otherwise alleviate aforementioned issue(s).

In one aspect, a method may involve a UE determining whether or not to disable PDCCH monitoring. Based on a result of the determining, the method may involve the UE either: (i) disabling the PDCCH monitoring responsive to a condition being met; or (ii) performing the PDCCH monitoring. In some cases, the condition may include there being a collision with an SBFD configuration of the UE by one or more symbols occupied by a CORESET.

In another aspect, an apparatus implementable in a UE may include a transceiver and a processor coupled to the transceiver. The transceiver may be configured to communicate wirelessly. The processor may determine whether or not to disable PDCCH monitoring. Based on a result of the determining, the processor may either: (i) disable the PDCCH monitoring responsive to a condition being met; or (ii) perform the PDCCH monitoring. In some cases, the condition may include there being a collision with an SBFD configuration of the UE by one or more symbols occupied by a CORESET.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIOT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a block diagram of an example communication system in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to PDCCH monitoring in SBFD networks. According to the present disclosure, a number of possible solutions may be implemented separately or jointly. That is, although these possible solutions may be described below separately, two or more of these possible solutions may be implemented in one combination or another.

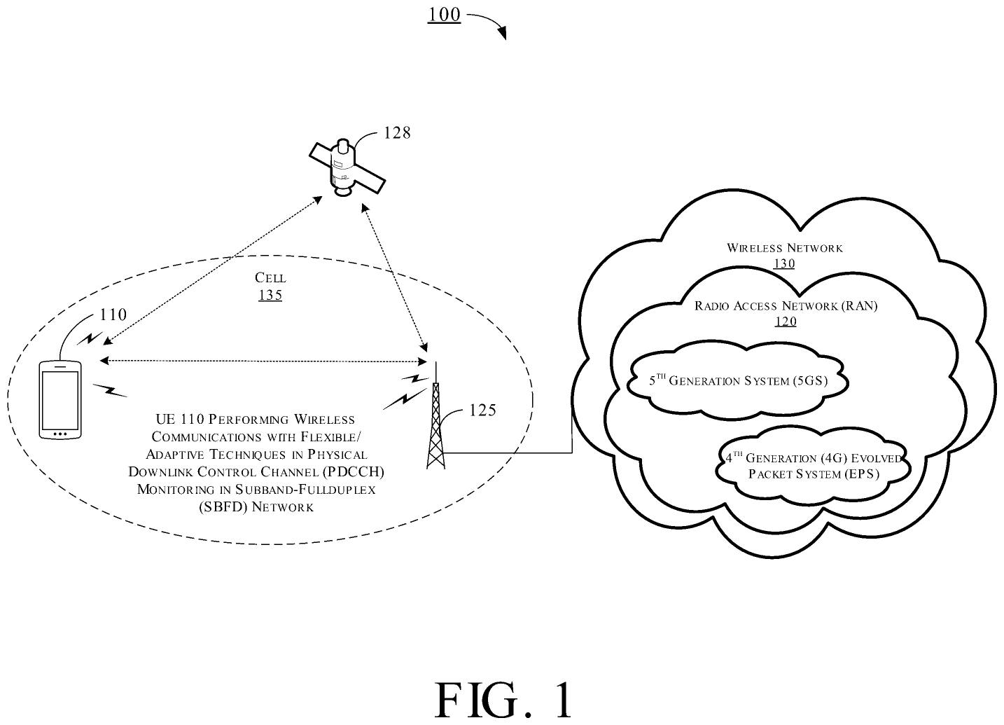

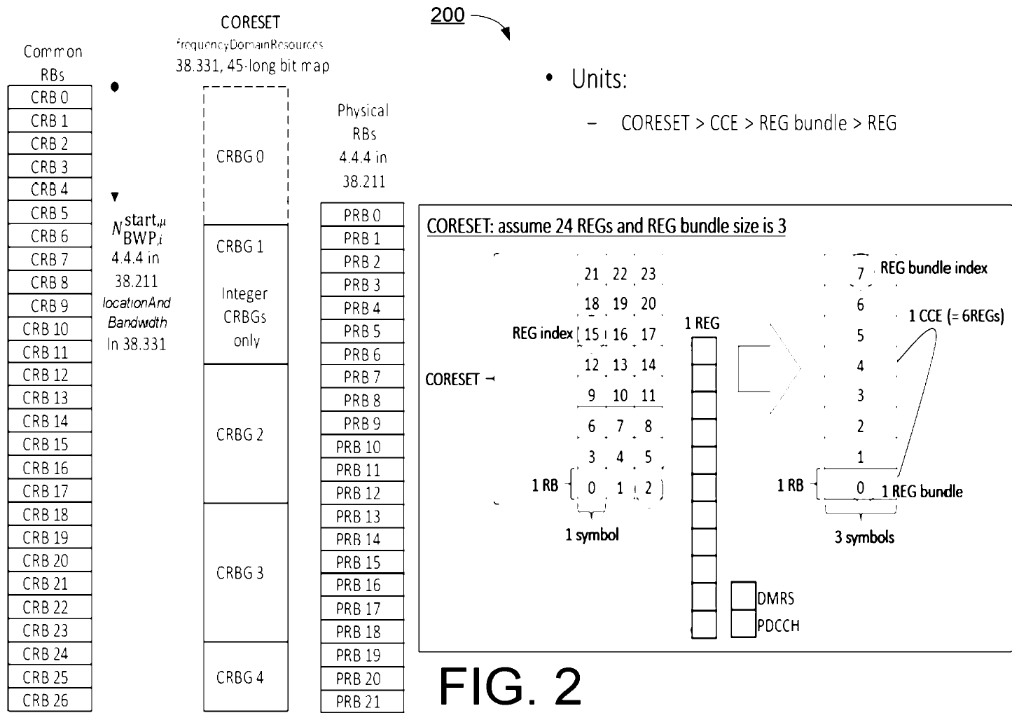

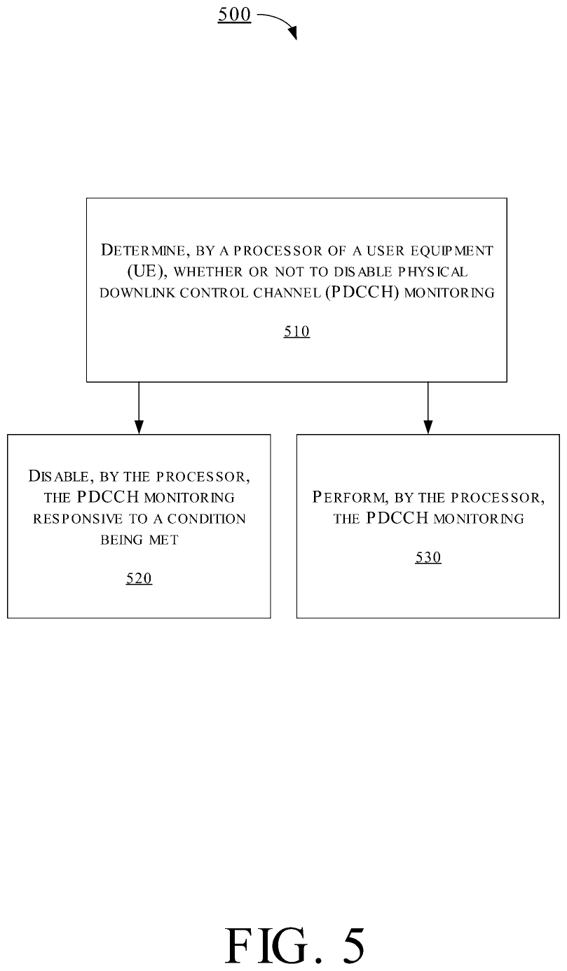

FIG. 1 illustrates an example network environment 100 in which various solutions and schemes in accordance with the present disclosure may be implemented. FIG. 2˜FIG. 5 illustrate examples of implementation of various proposed schemes in network environment 100 in accordance with the present disclosure. The following description of various proposed schemes is provided with reference to FIG. 1˜FIG. 5.

Referring to FIG. 1, network environment 100 may involve a UE 110 in wireless communication with a RAN 120 (e.g., a 5G NR mobile network or another type of network such as an NTN). UE 110 may be in coverage of a cell 135 corresponding to a base station or terrestrial network node 125 (e.g., an eNB, gNB or transmit-receive point (TRP)) and/or a non-terrestrial network node 128 (e.g., satellite). RAN 120 may be a part of a network 130. In network environment 100, UE 110 and network 130 (via terrestrial network node 125 and/or non-terrestrial network node 128 of RAN 120) may implement various schemes pertaining to PDCCH monitoring in SBFD networks, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all the proposed schemes, options and approaches may be implemented jointly.

FIG. 2 illustrates an example scenario 200 of frequency-domain resource allocation for CORESET. In the present disclosure, SBFD partition (format) refers to a partitioning of RBs into subbands. A DL subband is one RB or a set of contiguous RBs available for DL transmission in FDRAs. An UL subband is one RB or a set of contiguous RBs available for UL transmission in FDRAs. A subband partition format refers to a configuration that specifies all the subbands over the DL or UL BWP bandwidth or over the UE channel bandwidth. Scenario 200 is an example of FDRA for CORESET. In terms of units, CORESET is greater than CCE which is greater than resource element group (REG) bundle which is greater than REG.

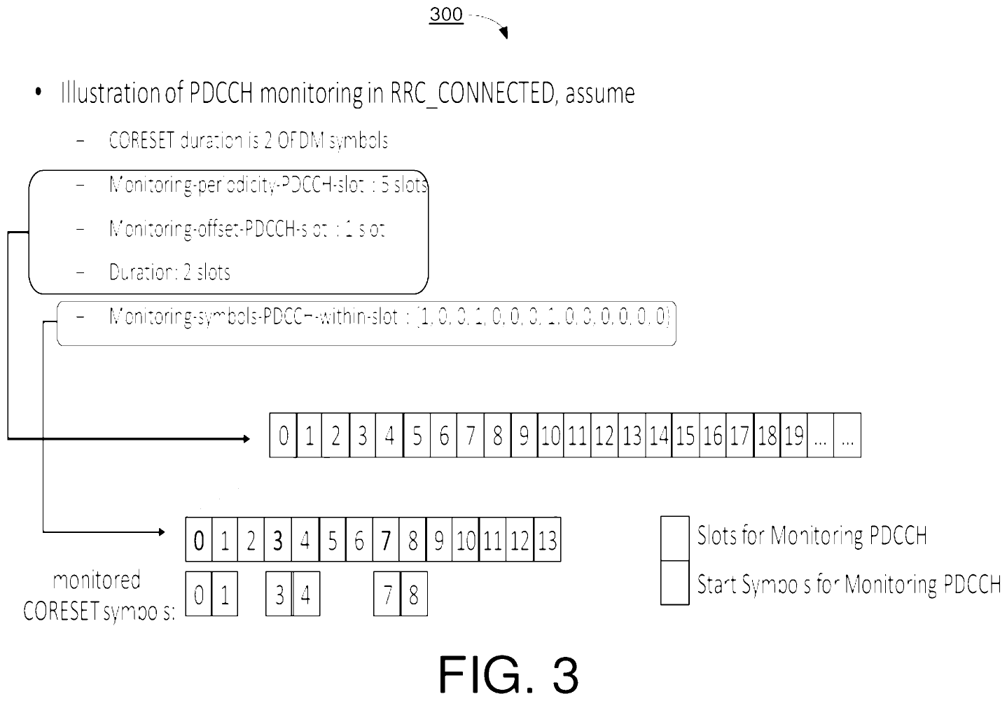

FIG. 3 illustrates an example scenario 300 related to search space. Specifically, scenario 300 is an example of search space symbol pattern, slot periodicity and slot offset. Some assumptions made by UE 110 in PDCCH monitoring when in radio resource control (RRC) connected mode may include, for example: (1) CORESET duration is two orthogonal frequency-division multiplexing (OFDM) symbols; (2) monitoring-periodicity-PDCCH-slot=5 slots; (3) monitoring-offset-PDCCH-slot=1 slot; (4) duration=2 slots; and (5) monitoring-symbols-PDCCH-within-slot=[1, 0, 0, 1, 0, 0, 0, 1, 0, 0, 0, 0, 0, 0].

Under a proposed scheme in accordance with the present disclosure with respect to adaptive disabling of PDCCH monitoring, PDCCH monitoring, as governed by CORESET and SearchSpace UE configurations, may be disabled adaptively in case that there is a collision between the SBFD-configuration of UE 110 and the symbols occupied by the CORESET. For instance, in case that UE 110 is configured or dynamically signaled by network 120 with an SBFD partition patterning over a set of symbols, and UE 110 is also configured with PDCCH monitoring over any symbol overlapping with the set of symbols, then PDCCH candidates may be not monitored on the overlapping symbol(s) in an event that there is a collision with the SBFD configuration of UE 110. Alternatively, or additionally, PDCCH monitoring may be disabled in the entire CORESET in an event that, for any of the symbols it occupies, there is a collision with the SBFD configuration of UE 110. Under the proposed scheme, the meaning of “collision with the SBFD configuration” of UE 110 may involve one or more of a plurality of conditions.

One condition may be that the SBFD partition format does not match the SBFD partition format that is configured for UE 110—as a new field—within the search space or within the CORESET configured with the search space. For instance, examples of SBFD partition format in this context may include: DL-only, UL-only, or [K RBs DL, L RBs UL, M RBs DL] (with each of K, L and M being a positive integer). The new field may be configured with up to one SBFD partition. Alternatively, the new field may be configured with zero, one or more than one SBFD partitions.

Another condition may be that any subband in the SBFD partition format does not match the subband that is configured for UE 110—as a new field—with the search space or with the CORESET configured with the search space. The new field may be configured with up to one subband. Alternatively, the new field may be configured with zero, one or more than one subbands.

A further condition may be that for each specific PDCCH candidate to be monitored—in the symbols or in the CORESET—the PDCCH candidate overlaps with any resource element (RE) that is configured as uplink, or guard gap or guard interval or slot format indication (SFI)—‘Flexible’.

Under a proposed scheme in accordance with the present disclosure with respect to adaptive selection of CORESET, each search space may be configured with one CORESET or more than one CORESETs, and a single CORESET may become active on each PDCCH monitoring occasion configured by the SearchSpace configuration. Under the proposed scheme, a single CORESET may be configured and may become active in case that all of the REs belonging to the CORESET are configured as DL according to the TDD frame format and SBFD partition pattern configured or signaled to UE 110. Alternatively, or additionally, multiple CORESETs may be configured and one of them may become active in case that all of the REs belonging to the CORESET are configured as DL according to the TDD frame format and SBFD partition pattern configured or signaled to UE 110. For instance, the condition may be verified for all CORESETs in an arbitrary (implementation-dependent) order until one CORESET becomes active. As another example, the CORESETs may be of the same duration. Alternatively, the CORESETs may be of different durations. Furthermore, under the proposed scheme, a default CORESET may be activated in case that SBFD partition is not defined in any of the slots/symbols occupied by the CORESETs.

Under a proposed scheme in accordance with the present disclosure with respect to flexible search space slot pattern, the search space may be configured either with a single offset or with a list of offsets corresponding to the same periodicity. For instance, parameter monitoringSlotPeriodicityAndOffset may take a sequence of offset parameter values. Alternatively, or additionally, a new field may be introduced, holding a bit pattern, which may indicate a slot pattern over a period length equal to the length of the bit pattern. When parameter bitpattern is configured, it may override parameter monitoringSlotPeriodicityAndOffset and parameter duration. When the bit pattern is empty, parameter monitoringSlotPeriodicityAndOffset and parameter duration may take effect. Alternatively, or additionally, a new field may be introduced, holding a bit pattern, which may indicate a slot pattern over a period length equal to the length of the bit pattern. When the parameter bitpattern is configured, it may override parameter monitoringSlotPeriodicityAndOffset. When the bit pattern is empty, monitoringSlotPeriodicityAndOffset may take effect.

### Illustrative Implementations

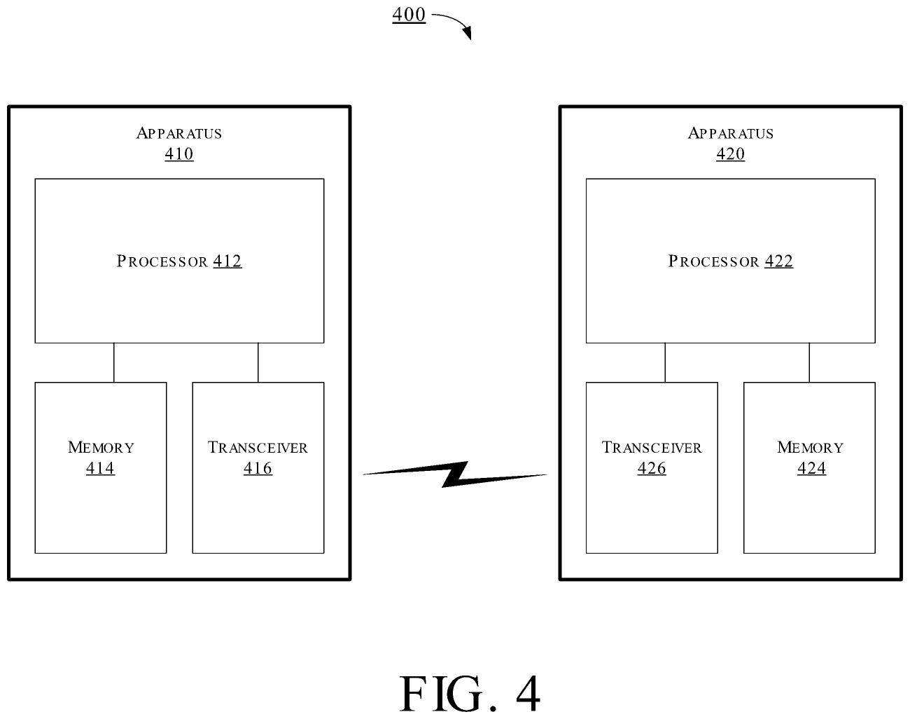

FIG. 4 illustrates an example communication system 400 having at least an example apparatus 410 and an example apparatus 420 in accordance with an implementation of the present disclosure. Each of apparatus 410 and apparatus 420 may perform various functions to implement schemes, techniques, processes and methods described herein pertaining to PDCCH monitoring in SBFD networks, including the various schemes described above with respect to various proposed designs, concepts, schemes, systems and methods described above, including network environment 100, as well as processes described below.

Each of apparatus 410 and apparatus 420 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 410 and apparatus 420 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 410 and apparatus 420 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 410 and apparatus 420 may be implemented in a smart thermostat, a smart fridge, a smart door lock, a wireless speaker or a home control center. When implemented in or as a network apparatus, apparatus 410 and/or apparatus 420 may be implemented in an cNodeB in an LTE, LTE-Advanced or LTE-Advanced Pro network or in a gNB or TRP in a 5G network, an NR network or an IoT network.

In some implementations, each of apparatus 410 and apparatus 420 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 410 and apparatus 420 may be implemented in or as a network apparatus or a UE. Each of apparatus 410 and apparatus 420 may include at least some of those components shown in FIG. 4 such as a processor 412 and a processor 422, respectively, for example. Each of apparatus 410 and apparatus 420 may further include one or more other components not pertinent to the proposed scheme of the present disclosure (e.g., internal power supply, display device and/or user interface device), and, thus, such component(s) of apparatus 410 and apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC or RISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged, and configured to perform specific tasks including those pertaining to PDCCH monitoring in SBFD networks in accordance with various implementations of the present disclosure.

In some implementations, apparatus 410 may also include a transceiver 416 coupled to processor 412. Transceiver 416 may be capable of wirelessly transmitting and receiving data. In some implementations, transceiver 416 may be capable of wirelessly communicating with different types of wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs/wireless networks of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of apparatus 410 and apparatus 420 may be a communication entity capable of communicating with each other using various proposed schemes in accordance with the present disclosure. For illustrative purposes and without limitation, a description of capabilities of apparatus 410, as a UE (e.g., UE 110), and apparatus 420, as a network node (e.g., terrestrial network node 125 or non-terrestrial network node 128) of a network (e.g., network 130 as a 5G/NR mobile network), is provided below.

Under various proposed schemes in accordance with the present disclosure pertaining to PDCCH monitoring in SBFD networks, processor 412 of apparatus 410, implemented in or as UE 110, may determine whether or not to disable PDCCH monitoring. Based on a result of the determining, processor 412 may either: (i) disable, via transceiver 416, the PDCCH monitoring responsive to a condition being met; or (ii) perform, via transceiver 416, the PDCCH monitoring.

In some implementations, the condition may involve there being a collision with an SBFD configuration of the UE by one or more symbols occupied by a CORESET. In some implementations, the collision with the SBFD configuration of the UE may involve an SBFD partition format not matching a configured SBFD partition format that is configured within a search space or within the CORESET configured with the search space.

In some implementations, the SBFD partition format may include DL only, UL only, or [K RBs DL, L RBs UL, M RBs DL] with each of K, L and M being a positive integer. In some implementations, the configured SBFD partition format may be configured as a new field with up to one SBFD partition. Alternatively, the configured SBFD partition format may be configured as a new field with up to zero, one or more than one SBFD partitions.

In some implementations, the collision with the SBFD configuration of the UE may involve any subband in an SBFD partition format not matching a configured subband that is configured within a search space or within the CORESET configured with the search space. In some implementations, the configured SBFD partition format may be configured as a new field with up to one subband. Alternatively, the configured SBFD partition format may be configured as a new field with up to zero, one or more than one subbands.

In some implementations, responsive to the PDCCH monitoring being performed, a PDCCH candidate among one or more PDCCH candidate being monitored may overlap with an RE that is configured as uplink (UL) or guard gap or guard interval or SFI—‘Flexible’.

In some implementations, the condition may involve: (i) the UE being configured or dynamically signaled with an SBFD partition pattern over a set of symbols; and (ii) the UE also being configured with the PDCCH monitoring over one or more symbols overlapping with the set of symbols. Moreover, in disabling the PDCCH monitoring, processor 412 may disable monitoring of one or more PDCCH candidates on the one or more overlapping symbols responsive to there being a collision between an SBFD configuration of the UE and the one or more overlapping symbols.

In some implementations, in disabling the PDCCH monitoring, processor 412 may disable the PDCCH monitoring in an entire CORESET responsive to there being a collision between one or more symbols occupied by the CORESET and an SBFD configuration of the UE.

In some implementations, each search space of one or more search spaces in a slot may be configured with one or more than one CORESETs. Moreover, a single CORESET of the one or more CORESETs may be active on each PDCCH monitoring occasion configured by a search space configuration.

In some implementations, the single CORESET may be configured and may become active responsive to all REs belonging to the single CORESET being configured as DL according to a TDD frame format and an SBFD partition pattern configured or signaled to the UE.

In some implementations, the one or more CORESETs may include multiple CORESETs that are configured with one of the multiple CORESETs being the single CORESET that becomes active responsive to all REs belonging to the single CORESET being configured as DL according to TDD frame format and an SBFD partition pattern configured or signaled to the UE. In some implementations, the condition may be verified for all the multiple CORESETs in an arbitrary order until the one of the multiple CORESETs becomes active. In some implementations, the multiple CORESETs may have a same duration. Alternatively, the multiple CORESETs may have different durations.

In some implementations, a default CORESET, as the single CORESET, may be activated responsive to an SBFD partition not being defined in any slot or symbol occupied by the one or more CORESETs.

In some implementations, each search space of one or more search spaces in a slot may be configured either with a single offset or with a list of offsets corresponding to a same periodicity.

### Illustrative Processes

FIG. 5 illustrates an example process 500 in accordance with an implementation of the present disclosure. Process 500 may represent an aspect of implementing various proposed designs, concepts, schemes, systems and methods described above, whether partially or entirely, including those pertaining to those described above. More specifically, process 500 may represent an aspect of the proposed concepts and schemes pertaining to PDCCH monitoring in SBFD networks. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in apparatus 410 and apparatus 420 as well as any variations thereof. Solely for illustrative purposes and without limiting the scope, process 500 is described below in the context of apparatus 410 as a UE (e.g., UE 110) and apparatus 420 as a communication entity such as a network node or base station (e.g., terrestrial network node 125 or non-terrestrial network node 128) of a network (e.g., network 130 as a 5G/NR mobile network). Process 500 may begin at block 510.

At 510, process 500 may involve processor 412 of apparatus 410 determining whether or not to disable PDCCH monitoring. Based on a result of the determining, process 500 may proceed from 510 to either 520 or 530.

At 520, process 500 may involve processor 412 disabling, via transceiver 416, the PDCCH monitoring responsive to a condition being met.

At 530, process 500 may involve processor 412 performing, via transceiver 416, the PDCCH monitoring.

In some implementations, the condition may involve there being a collision with an SBFD configuration of the UE by one or more symbols occupied by a CORESET. In some implementations, the collision with the SBFD configuration of the UE may involve an SBFD partition format not matching a configured SBFD partition format that is configured within a search space or within the CORESET configured with the search space.

In some implementations, the SBFD partition format may include DL only, UL only, or [K RBs DL, L RBs UL, M RBs DL] with each of K, L and M being a positive integer. In some implementations, the configured SBFD partition format may be configured as a new field with up to one SBFD partition. Alternatively, the configured SBFD partition format may be configured as a new field with up to zero, one or more than one SBFD partitions.

In some implementations, the collision with the SBFD configuration of the UE may involve any subband in an SBFD partition format not matching a configured subband that is configured within a search space or within the CORESET configured with the search space. In some implementations, the configured SBFD partition format may be configured as a new field with up to one subband. Alternatively, the configured SBFD partition format may be configured as a new field with up to zero, one or more than one subbands.

In some implementations, responsive to the PDCCH monitoring being performed, a PDCCH candidate among one or more PDCCH candidate being monitored may overlap with an RE that is configured as uplink (UL) or guard gap or guard interval or SFI—‘Flexible’.

In some implementations, the condition may involve: (i) the UE being configured or dynamically signaled with an SBFD partition pattern over a set of symbols; and (ii) the UE also being configured with the PDCCH monitoring over one or more symbols overlapping with the set of symbols. Moreover, in disabling the PDCCH monitoring, process 500 may involve processor 412 disabling monitoring of one or more PDCCH candidates on the one or more overlapping symbols responsive to there being a collision between an SBFD configuration of the UE and the one or more overlapping symbols.

In some implementations, in disabling the PDCCH monitoring, process 500 may involve processor 412 disabling the PDCCH monitoring in an entire CORESET responsive to there being a collision between one or more symbols occupied by the CORESET and an SBFD configuration of the UE.

In some implementations, each search space of one or more search spaces in a slot may be configured with one or more than one CORESETs. Moreover, a single CORESET of the one or more CORESETs may be active on each PDCCH monitoring occasion configured by a search space configuration.

In some implementations, the single CORESET may be configured and may become active responsive to all REs belonging to the single CORESET being configured as DL according to a TDD frame format and an SBFD partition pattern configured or signaled to the UE.

In some implementations, the one or more CORESETs may include multiple CORESETs that are configured with one of the multiple CORESETs being the single CORESET that becomes active responsive to all REs belonging to the single CORESET being configured as DL according to TDD frame format and an SBFD partition pattern configured or signaled to the UE. In some implementations, the condition may be verified for all the multiple CORESETs in an arbitrary order until the one of the multiple CORESETs becomes active. In some implementations, the multiple CORESETs may have a same duration. Alternatively, the multiple CORESETs may have different durations.

In some implementations, a default CORESET, as the single CORESET, may be activated responsive to an SBFD partition not being defined in any slot or symbol occupied by the one or more CORESETs.

In some implementations, each search space of one or more search spaces in a slot may be configured either with a single offset or with a list of offsets corresponding to a same periodicity.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of a user equipment (UE), whether or not to disable physical downlink control channel (PDCCH) monitoring; and
based on a result of the determining, either:
disabling, by the processor, the PDCCH monitoring responsive to a condition being met;
or
performing, by the processor, the PDCCH monitoring.

2. The method of claim 1, wherein the condition comprises there being a collision with a subband-fullduplex (SBFD) configuration of the UE by one or more symbols occupied by a control resource set (CORESET).

3. The method of claim 2, wherein the collision with the SBFD configuration of the UE comprises an SBFD partition format not matching a configured SBFD partition format that is configured within a search space or within the CORESET configured with the search space.

4. The method of claim 3, wherein the SBFD partition format comprises downlink (DL) only, uplink (UL) only, or [K RBs DL, L RBs UL, M RBs DL] with each of K, L and M being a positive integer.

5. The method of claim 3, wherein the configured SBFD partition format is configured as a new field with up to one SBFD partition.

6. The method of claim 3, wherein the configured SBFD partition format is configured as a new field with up to zero, one or more than one SBFD partitions.

7. The method of claim 2, wherein the collision with the SBFD configuration of the UE comprises any subband in an SBFD partition format not matching a configured subband that is configured within a search space or within the CORESET configured with the search space.

8. The method of claim 7, wherein the configured SBFD partition format is configured as a new field with up to one subband.

9. The method of claim 7, wherein the configured SBFD partition format is configured as a new field with up to zero, one or more than one subbands.

10. The method of claim 1, wherein, responsive to the PDCCH monitoring being performed, a PDCCH candidate among one or more PDCCH candidate being monitored overlaps with a resource element (RE) that is configured as uplink (UL) or guard gap or guard interval or slot format indication (SFI)-‘Flexible’.

11. The method of claim 1, wherein the condition comprises:
the UE being configured or dynamically signaled with a subband-fullduplex (SBFD) partition pattern over a set of symbols; and
the UE also being configured with the PDCCH monitoring over one or more symbols overlapping with the set of symbols, and
wherein the disabling of the PDCCH monitoring comprises disabling monitoring of one or more PDCCH candidates on the one or more overlapping symbols responsive to there being a collision between a subband-fullduplex (SBFD) configuration of the UE and the one or more overlapping symbols.

12. The method of claim 1, wherein the disabling of the PDCCH monitoring comprises disabling the PDCCH monitoring in an entire control resource set (CORESET) responsive to there being a collision between one or more symbols occupied by the CORESET and a subband-fullduplex (SBFD) configuration of the UE.

13. The method of claim 1, wherein each search space of one or more search spaces in a slot is configured with one or more than one CORESETs, and wherein a single CORESET of the one or more CORESETs is active on each PDCCH monitoring occasion configured by a search space configuration.

14. The method of claim 13, wherein the single CORESET is configured and becomes active responsive to all resource elements (REs) belonging to the single CORESET being configured as downlink (DL) according to a time-division duplex (TDD) frame format and a subband-fullduplex (SBFD) partition pattern configured or signaled to the UE.

15. The method of claim 13, wherein the one or more CORESETs comprise multiple CORESETs that are configured with one of the multiple CORESETs being the single CORESET that becomes active responsive to all resource elements (REs) belonging to the single CORESET being configured as downlink (DL) according to a time-division duplex (TDD) frame format and a subband-fullduplex (SBFD) partition pattern configured or signaled to the UE.

16. The method of claim 15, wherein the condition is verified for all of the multiple CORESETs in an arbitrary order until the one of the multiple CORESETs becomes active.

17. The method of claim 15, wherein the multiple CORESETs have a same duration.

18. The method of claim 15, wherein the multiple CORESETs have different durations.

19. The method of claim 13, wherein a default CORESET, as the single CORESET, is activated responsive to a subband-fullduplex (SBFD) partition being not defined in any slot or symbol occupied by the one or more CORESETs.

20. The method of claim 1, wherein each search space of one or more search spaces in a slot is configured either with a single offset or with a list of offsets corresponding to a same periodicity.
